(19) United States
(12) Patent Application Publication
(10) Pub. No.: US 2013/0007867 A1
(43) Pub. Date: Jan. 3, 2013

(54) Network Identity for Software-as-a-Service Authentication

(75) Inventors: Nathan Sowatskey, Madrid (ES); Einar Nilsen-Nygaard, Kilmarnock (GB); Matthew King, Hampshire (GB)

(73) Assignee: CISCO TECHNOLOGY, INC., San Jose, CA (US)

(21) Appl. No.: 13/173,194

(22) Filed: Jun. 30, 2011

(51) Int. Cl. H04L 29/06; G06F 15/16

(52) U.S. Cl. 726/8; 726/5

(57) ABSTRACT

Techniques are provided for asserting an identity of a client device with a server. A request is received from a client device to access processes hosted by the server. Network identifier information associated with the client device is obtained from the request. Confirmation of authentication of the client device is requested from an identity authentication server using the network identifier information. Access is provided to the client device for the processes hosted by the server when authentication of the client device is confirmed by the identity authentication server.

### TECHNICAL FIELD

The present disclosure relates to authenticating a network user for access to software services provided by a server.

### BACKGROUND

Software-as-a-service (SaaS) is a software distribution model where applications hosted by remote servers are accessed by user clients over a network. In order to access the SaaS applications, a client may need to assert proper identification to a SaaS server. SaaS server authentication is subject to issues of managing online client identities and the ability to manage corporate access to SaaS systems. In general, an identity provider authenticates a user to a network using a form-based authentication. The user, for example, may authenticate with a network device (e.g., laptop, personal computer, Internet Protocol phone, etc.) and may also authenticate to the network.

### BRIEF DESCRIPTION OF THE DRAWINGS

FIG. 1 shows an example network topology that supports client access and authentication for applications provided by a software-as-a-service (SaaS) server.

FIG. 2 is an example block diagram of a SaaS server configured with SaaS authentication and identification query logic to determine access privileges for a client device.

FIG. 3 is a diagram showing the entities involved in the process for the SaaS server to grant access to the client device.

FIG. 4 is an example ladder diagram depicting a process for a client device to authenticate with a network via an identity authentication server and to request access to the SaaS server.

FIG. 5 is a flow chart depicting operations of the SaaS authentication and identification query logic executed in the SaaS server to verify authentication of a client device.

### DESCRIPTION OF EXAMPLE EMBODIMENTS

Overview

Techniques are provided for asserting an identity of a client device with a server. A request is received from a client device to access processes hosted by the server. Network identifier information associated with the client device is obtained from the request. Confirmation of authentication of the client device is requested from an identity authentication server using the network identifier information. Access is provided to the client device for the processes hosted by the server when authentication of the client device is confirmed by the identity authentication server.

### Example Embodiments

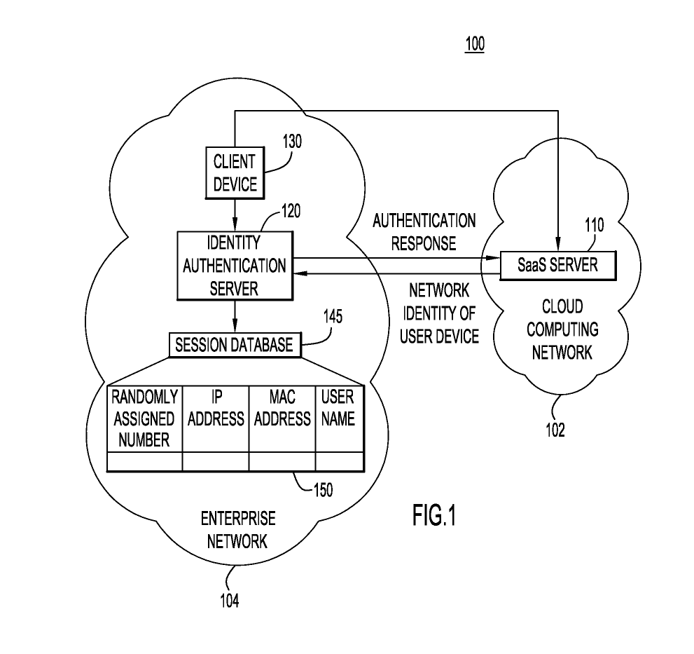

FIG. 1 shows an example of a network topology 100 featuring a cloud computing network 102 and an enterprise network 104. Cloud computing network 102 comprises a software-as-a-service (SaaS) server 110, which may be configured to host applications (e.g., email, networking, word processing, audio/video, etc.) and may store information (e.g., software management information, network security information, remote data backup, etc.) accessible by network clients that authenticate in network 104 via identity authentication server 120. Cloud computing network 102 may be owned or operated by the same entity that owns or operates the enterprise network 104 or may be a network independent of enterprise network 104. For example, cloud computing network 102 may be a private network in a data center that is owned and operated by enterprise network 102 or by a third party.

Enterprise network 104 comprises the identity authentication server 120, a client device 130, and session database 145. Identity authentication server 120 communicates with session database 145 to store information related to users/clients (e.g., client device 130) that authenticate with identity authentication server 120. For example, session database 145 may contain session data 150 that includes network identifier information, for each user/client device. In one example, the network identifier information comprises a random number assigned to client device 130, which can later be correlated to an active client device session (e.g., by SaaS server 110). In another example, the network identifier information comprises an Internet Protocol (IP) address and/or media access control (MAC) address and a user name for each user/client device. For example, data associated with client device 130 may be stored in session database 145 with a corresponding random number, IP address, MAC address and user name that is used when client device 130 authenticates with identity authentication server 120, as described herein. Though session data 150 shows a randomly assigned number (as described above), IP address and MAC address information associated with corresponding user names stored in session database 145, it should be appreciated that any network identifier that identifies client device 130 may be stored as session data 150, and that any such network identifier can be configured to be appended as parameters to hypertext transfer protocol (HTTP) headers, and so used by SaaS server 110 to lookup identity information in identity authentication server 120. It should also be appreciated that the techniques described herein are not limited to HTTP headers, and that other protocols could be used to carry the network information to a SaaS server, as described herein.

In general, client device 130 authenticates with identity authentication server 120, and information (e.g., data 150) pertaining to the authentication is stored in session database 145. Client device 130 also communicates with SaaS server 110 in order to request access to applications and/or information hosted by SaaS server 110. SaaS server 110 is configured to communicate with identity authentication server 120 to receive information pertaining to the authentication of client device 130, as described herein.

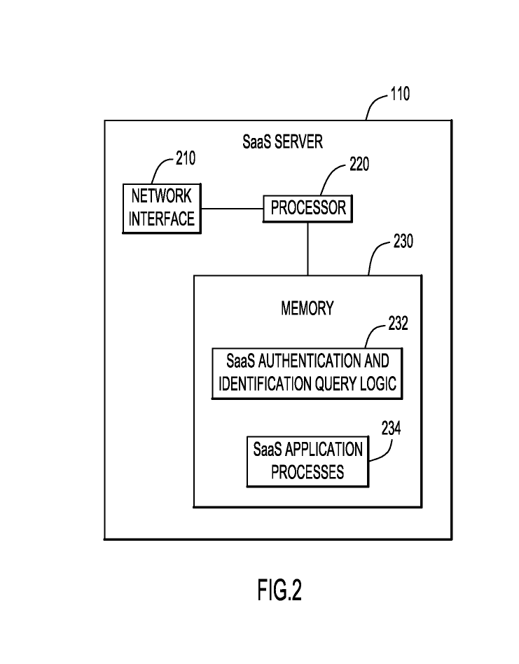

Turning to FIG. 2, an example block diagram of SaaS server 110 is now described. SaaS server 110 comprises a network interface device 210, a processor 220 and a memory 230. Network interface device 210 is configured to enable network communications to, for example, receive access requests from client device 130 and engage in providing services to client device 130. Processor 220 is coupled to network interface device 210 and to memory 230. Processor 220 is a microprocessor or microcontroller that is configured to execute program logic instructions (i.e., software) for carrying out various operations and tasks described herein. For example, processor 220 is configured to execute SaaS authentication and identification query logic 232 that is stored in memory 230 to obtain client authentication information in order to grant a user/client (e.g., through client device 130) access to applications or information hosted by SaaS server 110. Memory 230 may comprise read only memory (ROM), random access memory (RAM), magnetic disk storage media devices, optical storage media devices, flash memory devices, electrical, optical or other physical/tangible memory storage devices.

The functions of processor 220 may be implemented by logic encoded in one or more tangible computer readable storage media (e.g., embedded logic such as an application specific integrated circuit, digital signal processor instructions, software that is executed by a processor, etc), wherein memory 230 stores data used for the operations described herein and stores software or processor executable instructions that are executed to carry out the operations described herein.

SaaS authentication and identification query logic 232 may take any of a variety of forms, so as to be encoded in one or more tangible computer readable memory media or storage device for execution, such as fixed logic or programmable logic (e.g., software/computer instructions executed by a processor) and the processor 220 may be an application specific integrated circuit (ASIC) that comprises fixed digital logic, or a combination thereof. For example, the processor 220 may be embodied by digital logic gates in a fixed or programmable digital logic integrated circuit, which digital logic gates are configured to perform SaaS authentication and identification query logic 232. In general, SaaS authentication and identification query logic 232 may be embodied in one or more computer readable storage media encoded with software comprising computer executable instructions and when the software is executed operable to perform the operations described herein for the process logic 232.

As described above, SaaS server 110 may host applications and may store information accessible to network clients (e.g., client device 130) that are verified or confirmed as being authenticated by virtue of an assertion from identity authentication server 120. SaaS application processes shown at 234 are meant to include applications and information hosted by SaaS server 110 that are also stored in memory 230. In general, client device 130 can access and utilize SaaS application processes 234 after client device 130 is confirmed as being authenticated by assertion according to the techniques described herein.

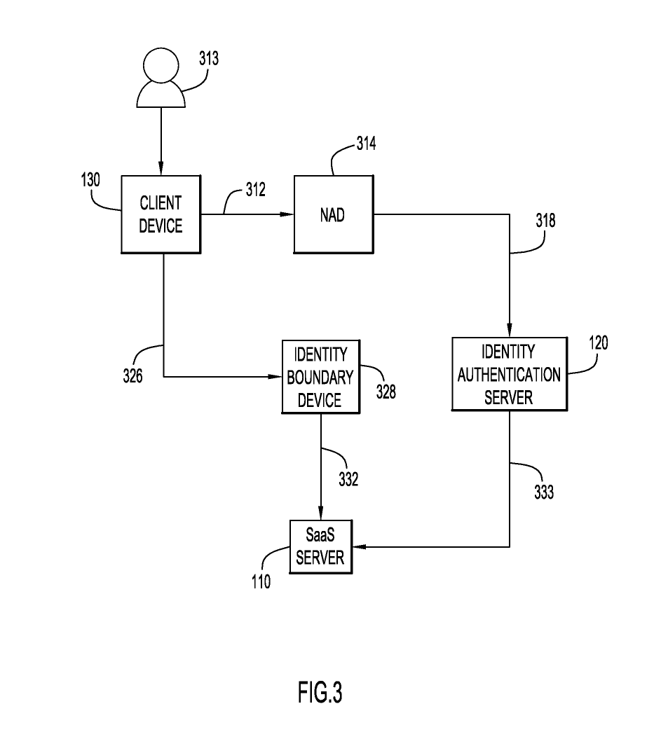

Reference is now made to FIG. 3. FIG. 3 shows a detailed layout of network topology 100, and in particular, shows the entities involved in the process for SaaS server 110 to grant access to client device 130. A user 313 interacts with client device 130 in order to communicate with a network access device (NAD) 314. NAD 314 may be any device that implements a set of control protocols to enable access for a device to a network. For example, as described herein, NAD 314 may implement policies or protocols to authenticate network devices for access to network resources. NAD 314, in turn, communicates with identity authentication server 120, which is configured to communicate with SaaS server 110, as described herein.

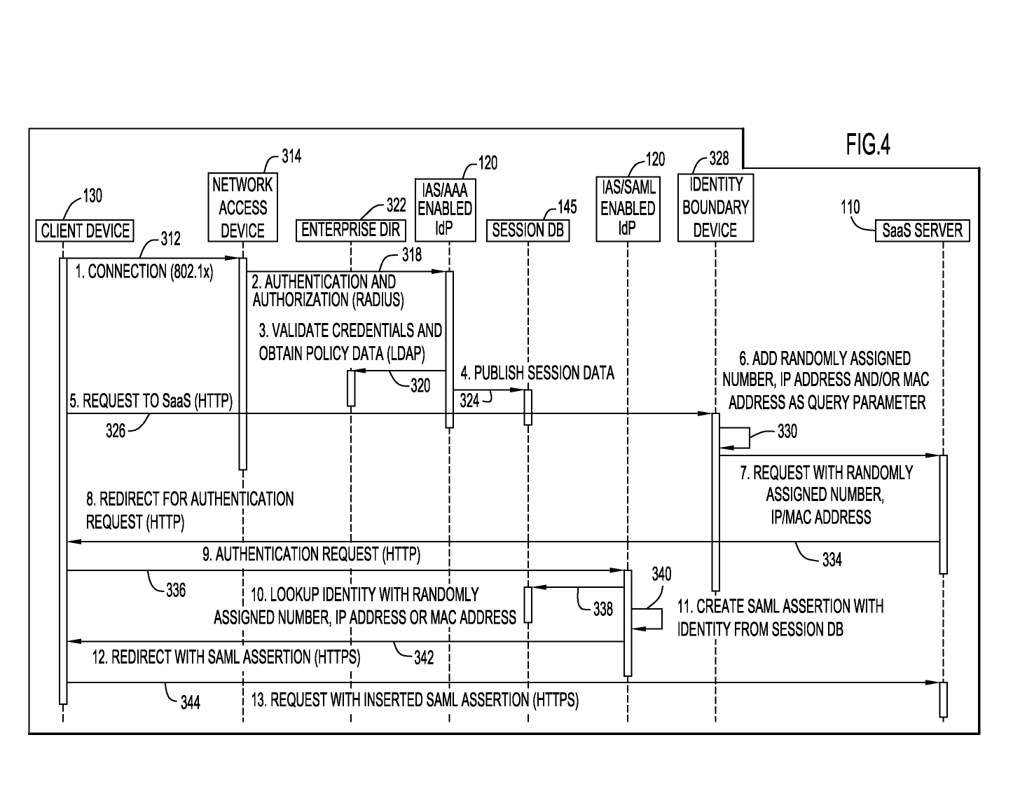

Client device 130 also, as described below, communicates with an identity boundary device 328. Identity boundary device 328 may be any device that is configured to receive access requests from client device 130 and to transmit these requests to SaaS server 110. Identity boundary device 328 communicates with SaaS server 110, which in turn, communicates with identity authentication server 120, for example, to verify or confirm authentication of client device 130, by receipt of an assertion, as described herein. The SaaS server 110 can directly request confirmation of authentication from the identity authentication server 120 as shown at 333 and described hereinafter. The communications between these network entities is now described in more detail, in reference to FIG. 4.

FIG. 4 is an example of a ladder diagram depicting a process for client device 130 to authenticate with identity authentication server 120 and to request access to SaaS server 110. In FIG. 4, client device 130 performs an Access Control authentication with identity authentication server 120. The Access Control authentication with identity authentication server 120 is shown in steps 312, 318 and 320, which are now described.

Client device 130 initiates a connection 312 to authenticate with NAD 314. Connection 312 is also shown in FIG. 3 between client device 130 (e.g., a personal computer) and NAD 314. After client device 130 initiates a connection with NAD 314, NAD 314 authenticates client device 130, for example, according to Institute for Electrical and Electronic Engineers (IEEE) authentication standard 802.1x. For example, NAD 314 may authenticate client device 130 by verifying a user name and password entered by user 316 and associated with client device 130. It should be appreciated, however, that any authentication standard may be used to authenticate client device 130, and the IEEE 802.1x authentication standard is only an example. Client device 130 may be a secure personal computer (PC) that is configured to connect to network 102 in FIG. 1. Additionally, connection 312 may be established, for example, such that devices only with known or permitted MAC addresses are able to connect with NAD 314.

After client device 130 authenticates with NAD 314, NAD 314 authenticates with identity authentication server 120 at 318 as part of the Access Control authentication process. Identity authentication server 120 may utilize, for example, a remote authentication dial-in user service (RADIUS) protocol to perform authentication, authorization and accounting (AAA) operations in order to authenticate NAD 314 and associated client device 130 with identity authentication server 120. The AAA operations may be performed, for example, on a centralized server or may be performed within identity authentication server 120. For simplicity, FIG. 4 shows AAA operations being performed at identity authentication server 120. During authentication 318, identity authentication server 120 may, for example, associate a randomly assigned number, IP address or MAC address assigned to client device 130 with a user name entered by user 316 and used by client device 130 to authenticate with NAD 314. Upon authenticating NAD 314 and client device 130, identity authentication server 120, at 320, communicates with an enterprise directory 322 in order to validate credentials associated with client device 130 and NAD 314, as part of the Access Control authentication process. Identity authentication server 120 may obtain policy data associated with client device 130 and NAD 314 (e.g., via a Lightweight Directory Access Protocol) from enterprise directory 322.

After the Access Control authentication process has been completed (i.e., after operations 312, 318 and 320 have been performed), identity authentication server 120, at 324, stores the authentication information (e.g., IP address and associated user name) of client device 130 in session database 145. As described above, session database 145 may store data 150 (in FIG. 1) including a randomly assigned number associated with a client device, an IP address, MAC address and user name (e.g., an IEEE 802.1x identifier) for multiple client devices in order to verify each client device as a permitted client for SaaS server 110.

As stated above, SaaS server 110 may host SaaS application processes 234 comprising, for example, software applications and/or information. Client device 130 may access the application processes by sending a request for access to SaaS server 110. However, before SaaS server 110 provides access to client device 130, SaaS server 110 needs to obtain an assertion that client device 130 has authenticated with identity authentication server 120. For example, the SaaS server 110 may obtain a Security Assertion Markup Language (SAML) assertion, though it should be appreciated that any authentication and authorization assertion may be used. The assertion may contain, for example, an identity associated with client device 130. The assertion is populated based on the identity used when client device 130 authenticates with identity authentication server 120, which would typically be a user name associated with user 316 of client device 130, as stored in session database 145. Thus, the identity contained within the assertion obtained by SaaS server 110 may, for example, be the same user name associated with user 316 of client device 130. The request to access SaaS server 110 by client device 130 and the verification of authentication of client device 110 is now described.

After client device 130 has authenticated with NAD 314 and identity authentication server 120, client device 130 subsequently sends a request 326 to identity boundary device 328. Identity boundary device 328 may receive request 326 directly from client device 130 (e.g., via an authentication request or attribute query) or may receive request 326 by intercepting a request that is intended for SaaS server 110. In one example, request 326 may be received by identity boundary device 328 if it is in a data path between client device 130 and SaaS server 110. In another example, request 326 may be received by identity boundary device 328 if a network router redirects request 326 (for example, through a web cache communication protocol (WCCP)) to identity boundary device 328.

After identity boundary device 328 receives request 326 from client device 130, identity boundary device 328 appends, at 330, a network identifier associated with client device 130 to a header of request 326. For example, identity boundary device 328 may append the randomly assigned number, IP address or MAC address associated with client device 130 to an HTTP header of request 326. After identity boundary device 328 appends the network identifier information to a header of request 326, at 332, the request with the network identifier information (e.g., the randomly assigned number, IP address and/or MAC address associated with client device 130) is sent to SaaS server 110. In one example, identity boundary device 328 transparently appends the network identifier to the header of request 326, and accordingly, since identity boundary device 328 is transparent in the communication path between client device 130 and SaaS server 110, identity boundary device 328 may not communicate directly with SaaS server 110. Instead, client device 130 may receive request 326 with the network identifier information added by identity boundary device 328, and may send this request directly to SaaS server 110. It should be appreciated that identity boundary device 328 is configured to evaluate uniform resource locators (URLs) associated with request 326 in order to determine whether to append the network identifier to the header of request 326 (i.e., into the URL address), and whether to effect redirection to the client device or retransmit the request to the SaaS server 110.

After SaaS server 110 receives the request with the network identifier information, SaaS server 110 needs to obtain an assertion that client device 130 has authenticated with identity authentication server 120. Accordingly, SaaS server 110 requests confirmation of authentication of client device 130 from identity authentication server 120 using the network identifier information. In one example, SaaS server 110 may request confirmation of authentication directly from identity authentication server 120 as indicated by connection 333 in FIG. 3. SaaS server 110 may also request authentication from identity authentication server 120 by redirecting the request from client device 130 back to client device 130 so that client device 130 obtains authentication from identity authentication server 120. In another example, SaaS server 110 redirects a security assertion markup language (SAML) request to client device 130 to obtain authentication from identity authentication server 120. An example of this redirect flow is now described.

At 334, SaaS server 110 initiates a redirect (e.g., an HTTP redirect) to client device 130 for a request for authentication from identity authentication server 120. For example, a web browser of client device 130 may support a single sign-on (SSO) profile as part of the SAML request to allow user 316 of client device 130 to access both identity authentication server 120 and SaaS server 110. In one example, the SaaS server 110 can query the identity boundary device 328 directly for a request for authentication via, for example, an external IP address of the identity authentication server 120, and the identity boundary device 328 can, in turn, query the identity authentication sever 120. When client device 130 receives the redirected authentication request 334, client device 130 (via, e.g., a SSO supported web browser) responds to the redirected authentication request 334 by sending an authentication request 336 to identity authentication server 120. Upon receiving authentication request 336, identity authentication server 120, at 338, correlates network identifier information contained within authentication request 336 with data stored in session database 145 for client device 130. For example, if authentication request 336 contains an IP address associated with client device 130, identity authentication server 120 can evaluate data in session database 145 to determine whether or not a client device with that IP address has been authenticated by identity authentication server 120. If an identity associated with client device 130 has been authenticated by identity authentication server 120, identity authentication server 120, at 340, creates a signed assertion indicating that the identity associated with client device 130 has been authenticated. For example, identity authentication serve 120 may create a SAML assertion and may encode within the SAML assertion the mechanism of authentication. This allows a level of assurance for SaaS server 110 to know the degree to which it can rely on the authentication mechanism. For example, different SaaS servers 110 may require different levels of assurance for different sets of data or services.

In one example, the signed assertion may be a SAML assertion. SAML is a protocol used for exchanging assertions about authentication and attributes associated with a client device. A service provider (e.g., SaaS server 110) can use SAML to query an identity provider (e.g., identity authentication server 120) for authentication associated with a particular client device. In response to the query, the identity provider may provide authentication information to the service provider. This authentication information allows the service provider to establish a trust relationship with the identity provider, which allows the service provider to rely upon the identity provider assertions as being true. For example, if the identity provider indicates that a client device has been authenticated, the service provider will grant the client device access, with appropriate access controls based on the client device status.

After creating the signed assertion, identity authentication server 120 transmits signed assertion, at 342, to client device 130 using, for example, an HTTP secure (HTTPS) protocol. Client device 130, at 344, transmits the signed assertions to SaaS server 110. Thus, SaaS server 110 is able to obtain an assertion that client device 130 has been authenticated by identity authentication server 120, and accordingly, SaaS server 110 can permit client device 130 to access SaaS application processes 234 hosted by SaaS server 110.

Thus, by receiving authentication information (e.g., a signed assertion) from identity authentication server 120, SaaS server 110 can enable a single sign-on for client device 130, allowing client device 130 to access SaaS application processes 234 without having to authenticate again.

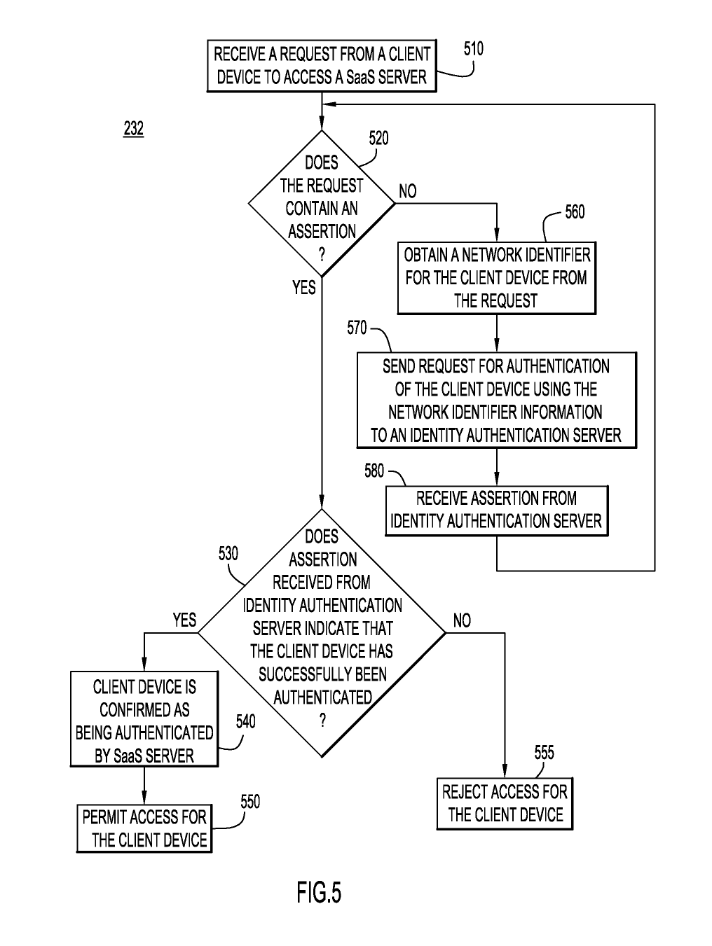

Reference is now made to FIG. 5. FIG. 5 shows an example flow chart depicting operations performed by processor 220 of SaaS server 110 according to SaaS authentication and identification query logic 232. At 510, SaaS server 110 receives a request from client device 130 to access processes hosted by SaaS server 110. These processes may be, for example, SaaS application processes 234. After receiving the request, at 520, it is determined whether the request contains an assertion of authentication associated with client device 130. If the request contains an assertion of authentication, at step 530, it is determined whether the assertion received from identity authentication server 120 indicates that client device 130 has successfully been authenticated. If the assertion does indicate that client device 130 has successfully been authenticated, at 540, client device is confirmed by SaaS server 110 as being authenticated, and at 550, access to SaaS server 110 is permitted for client device 130. If the assertion does not indicate that client device 130 has successfully been authenticated, at 555, access to SaaS server 110 is rejected/denied for client device 130. If the request does not contain an assertion of authentication (i.e., if the result at 520 is “no”), at 560, a network identifier (e.g., the randomly assigned number, MAC address, or IP address associated with client device 130) is obtained for client device 130. In one example, the network identifier is obtained from a header of the request. At 570, a request for authentication of client device 130 using the network identifier information is sent to identity authentication server 120. At 580, an assertion is received from identity authentication server 120. The process then reverts back to step 520 to determine whether the request contains an assertion of authentication.

It should be appreciated that the techniques described above in connection with all embodiments may be performed by one or more computer readable storage media that is encoded with software comprising computer executable instructions to perform the methods and steps described herein.

In sum, a method is provided comprising: at a server, receiving a request from a client device to access processes hosted by the server; obtaining from the request network identifier information associated with the client device; requesting confirmation of authentication of the client device using the network identifier information from an identity authentication server; and providing access to the client device for the processes hosted by the server when authentication of the client device is confirmed by the identity authentication server.

In addition, one or more computer readable storage media is provided encoded with software comprising computer executable instructions and when the software is executed operable to: receive a request from a client device to access processes hosted by a server; obtain from the request network identifier information associated with the client device; request confirmation of authentication of the client device using the network identifier information from an identity authentication server; and provide access to the client device for the processes hosted by the server when authentication of the client device is confirmed by the identity authentication server.

Further, an apparatus is provided comprising a network interface device configured to enable communications over a network, a memory and a processor. The processor is coupled to the network interface device and the memory and is configured to receive a request from a client device to access processes hosted by a server; obtain from the request network identifier information associated with the client device; request confirmation of authentication of the client device using the network identifier information from an identity authentication server; and provide access to the client device for the processes hosted by the server when authentication of the client device is confirmed by the identity authentication server.

The above description is intended by way of example only. Various modifications and structural changes may be made therein without departing from the scope of the concepts described herein and within the scope and range of equivalents of the claims.

What is claimed is:

1. A method comprising:
at a server, receiving a request from a client device to access processes hosted by the server;
obtaining from the request network identifier information associated with the client device;
requesting confirmation of authentication of the client device using the network identifier information from an identity authentication server; and
providing access to the client device for the processes hosted by the server when authentication of the client device is confirmed by the identity authentication server.

2. The method of claim 1, wherein obtaining the network identifier information comprises obtaining an Internet Protocol (IP) address associated with the client device from a header of the request.

3. The method of claim 1, wherein obtaining the network identifier information comprises obtaining a media access control (MAC) address associated with the client device from a header of the request.

4. The method of claim 1, wherein obtaining the network identifier information comprises obtaining a random number associated with the client device from a header of the request.

5. The method of claim 1, wherein requesting comprises redirecting the request to the client device such that the client device obtains the authentication from the identity authentication server.

6. The method of claim 5, wherein requesting comprises requesting an assertion of authentication from the identity authentication server using a security assertion markup language (SAML) protocol.

7. The method of claim 1, wherein requesting comprises requesting a signed assertion directly from the identity authentication server.

8. The method of claim 1, wherein providing comprises providing access to the server using an assertion of authentication as a single sign-on authentication identifier to authenticate the client device.

9. The method of claim 1, wherein obtaining comprises obtaining the network identifier information from a hypertext transfer protocol (HTTP) header of the request.

10. The method of claim 1, wherein the network identifier information associated with the client device is associated with the client device for a session established for the client device at the identity authentication server.

11. One or more computer readable storage media encoded with software comprising computer executable instructions and when the software is executed operable to:
receive a request from a client device to access processes hosted by a server;
obtain from the request network identifier information associated with the client device;
request confirmation of authentication of the client device using the network identifier information from an identity authentication server; and
provide access to the client device for the processes hosted by the server when authentication of the client device is confirmed by the identity authentication server.

12. The computer readable storage media of claim 11, wherein the instructions that are operable to obtain comprise instructions that are operable to obtain an Internet Protocol (IP) address associated with the client device from a header of the request.

13. The computer readable storage media of claim 11, wherein the instructions that are operable to obtain comprise instructions that are operable to obtain a media access control (MAC) address associated with the client device from a header of the request.

14. The computer readable storage media of claim 11, wherein the instructions that are operable to request comprise instructions that are operable to redirect the request to the client device such that the client device obtains authentication from the identity authentication server.

15. The computer readable storage media of claim 14, wherein the instructions that are operable to request comprise instructions that are operable to request an assertion of authentication from the identity authentication server using a security assertion markup language (SAML) protocol.

16. The computer readable storage media of claim 11, wherein the instructions that are operable to obtain comprise instruction operable to obtain the network identifier information from a hypertext transfer protocol (HTTP) header of the request.

17. An apparatus comprising:
a network interface device configured to enable communications over a network; and
a processor coupled to the network interface device and configured to:
receive via the network interface a request from a client device to access processes hosted by a server;
obtain from the request network identifier information associated with the client device;
request confirmation of authentication of the client device using the network identifier information from an identity authentication server; and
provide access to the client device for the processes hosted by the server when authentication of the client device is confirmed by the identity authentication server.

18. The apparatus of claim 17, wherein the processor is further configured to obtain an Internet Protocol (IP) address associated with the client device from a header of the request.

19. The apparatus of claim 17, wherein the processor is further configured to obtain a media access control (MAC) address associated with the client device from a header of the request.

20. The apparatus of claim 17, wherein the processor is further configured to request an assertion of authentication from the identity authentication server using a security assertion markup language (SAML) protocol.

21. The apparatus of claim 17, wherein the processor is further configured to redirect the request to the client device such that the client device obtains authentication from the identity authentication server.
